(19) United States
(12) Patent Application Publication
(10) Pub. No.: US 2002/0097230 A1
(43) Pub. Date: Jul. 25, 2002

(54) Large-screen display with remote optical graphic interface

(75) Inventors: Brian C. Lowry, Emlenton, PA (US); Jerald F. Lowry, Pittsburgh, PA (US)

Correspondence Address: PEPPER HAMILTON LLP, 50th Floor, One Mellon Center, Pittsburgh, PA, 15219, US

(73) Assignee: Transvision, Inc.

(21) Appl. No.: 10/052,791

(22) Filed: Jan. 18, 2002

Related U.S. Application Data
(60) Provisional application No. 60/263,120, filed on Jan. 19, 2001.

(51) Int. Cl. G09G 5/00

(52) U.S. Cl. 345/175

(57) ABSTRACT

An apparatus for remote interface with a display includes a controlling computing or processing device and data acquisition apparatus, such as a data acquisition card housed within the controlling computer. The apparatus also includes an image projector, an input matrix, an array of display optical fibers, and an array of detection optical fibers. The apparatus further includes a display panel, a display and detection surface, a photosensor array, a plurality of light paths, and an optical pointing device for remote graphic interface with images on the display panel.

In another aspect, a method for interacting with a large screen display remote optical graphic interface system, includes the steps of receiving an activation beam, generating an electrical signal, determining the location of activated fiber(s), outputting a signal to a controlling computer, and executing software instructions responsive to the signal.

### CLAIM OF PRIORITY

This application claims priority to United States Provisional Patent Application No. 60/263,120, filed Jan. 19, 2001, which is incorporated herein by reference in its entirety.

### FIELD OF INVENTION

This application relates to image display devices. More particularly, this application relates to display devices that are capable of responding to received input.

### BACKGROUND OF THE INVENTION

A large screen displays (“LSD”) may be defined as any dynamic display that is sufficiently large to be viewed by a group of people at some distance from the display. The LSD market is diverse, with many differing products and technologies, each having certain strengths and weaknesses, competing to fill the needs of the end user. Applications requiring outdoor use in direct sunlight have traditionally been served best by cathode ray tube (“CRT”) and light-emitting diode (“LED”) displays, while indoor applications are served by video walls or front/rear projection systems. Fiber optic LSDs, however, offer substantial improvements over current CRT- and LED-based displays, due to their smaller depth, lighter weight, and elimination of sensitive and expensive electronic components on the surface of the display, while delivering superior resolution and adequate brightness for direct sunlight applications. Fiber optic LSDs are also superior to video walls because of the lack of mullions, improved brightness and color uniformity, more rugged design, and thinner construction. Finally, fiber optic displays have many advantages over projection systems, including all the above advantages over video walls, as well as the fact that the display unit can be more easily moved and installed.

Although the presence of LSDs in public venues such as sports stadia have become quite common and even expected, many other possible venues have been overlooked. If the technology driving LSDs were to become more applicable to a variety of environments and, in addition, enabled for interaction with viewers of LSDs, the market could be expanded considerably. Advertisers, consumers, educators, and all manner of clients would benefit considerably from being able to directly interact with the material displayed. By developing a process that enables a remote graphic optical interface for LSDs, considerable value can be added to the LSD market.

Existing techniques for remote graphic interface with LSDs include projection systems linked to interface devices such as computer mice and light pens. These devices are often hard-wired to the display (or controlling hardware), limiting the user in his or her distance from, and movement around, the display. Existing wireless optical pointing devices are cumbersome, awkward to use, and are also limited in their useful range from the display. Thus, there is a need for an improved means of enabling a remote graphic interface to a fiber optic LSD.

### SUMMARY OF THE INVENTION

In accordance with a preferred embodiment, this invention comprises an apparatus for remote optical graphic interface with a display such as an LSD. The apparatus includes a detection surface panel, a plurality of optical detection fibers in communication with the surface panel, a photosensor array in optical communication with the detection fiber array, and a plurality of optical display fibers in optical communication with the surface panel. It also includes an input matrix that is optically connected to the optical display fibers, and an image projector that is positioned to transmit an image through the input matrix and the optical display fibers to the surface panel.

Optionally, the system also comprises a computing device, and the image projector and the photosensor array are both in communication with the computer. Further, the surface panel may be connected to a support structure that is designed to support a plurality of surface panels. In such an embodiment, the surface panel has a surface area larger than the surface area of the input matrix, and the display fibers are arranged so that the image is magnified when transmitted from the input matrix to the surface panel.

Also optionally, each of the display fibers and each of the detection fibers has an end-point, and the display fibers and detection fibers are arranged so that both the display fiber end points and the detection fiber end points are co-distributed uniformly across the surface panel. Preferably, the number of display fibers is greater than the plurality of detection fibers.

Further, the photosensor array may include at least one optical bandpass filter designed to pass predetermined light spectra and reflect or absorb other predetermined light spectra.

Also optionally, the system further includes an optical pointing device comprised of a targeting light source capable of emitting light having a first wavelength, a first actuator capable of turning the targeting light source on and off, an activation light source capable of emitting light having a second wavelength that is different from the first wavelength, and a second actuator capable of turning the activation light source on and off. In this embodiment, the targeting light source and the activation light source may optionally comprise a single light source that is capable of emitting both light having the first wavelength and light having the second wavelength. In addition, such a single light source may be capable of emitting light of a given wavelength having a first modulation frequency and light of the same wavelength having a second modulation frequency, wherein the first modulation frequency and the second modulation frequency are different, and either the first modulation frequency or the second modulation frequency, but not both, is preferably zero. Preferably, the first actuator and the second actuator comprise a single actuator having at least two modes of operation.

In accordance with an alternate embodiment, a method of displaying content to a user includes the steps of receiving light having a predetermined wavelength via a large screen display through a plurality of optical detection fibers, determining a location on the large screen display with which the light has communicated, using at least one photosensor to convert the light into an electrical signal, transmitting the electrical signal to a computing device having a data acquisition card, selecting a response to the electrical signal, and transmitting at least one image that corresponds to the response via a plurality of optical display fibers to the display surface.

### BRIEF DESCRIPTION OF THE DRAWINGS

FIG. 1A is an exemplary remote optical graphic interface system.

FIG. 1B is an exemplary display panel for the system.

FIG. 2 is an exemplary optical pointing device.

FIG. 3 is a means for interaction between a user and the remote optical graphic interface system.

### DETAILED DESCRIPTION OF PREFERRED EMBODIMENTS OF THE INVENTION

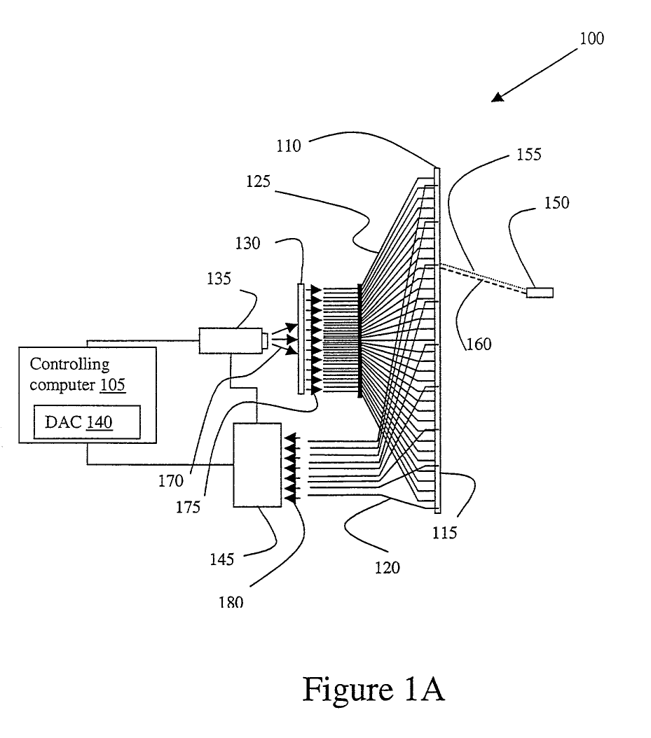

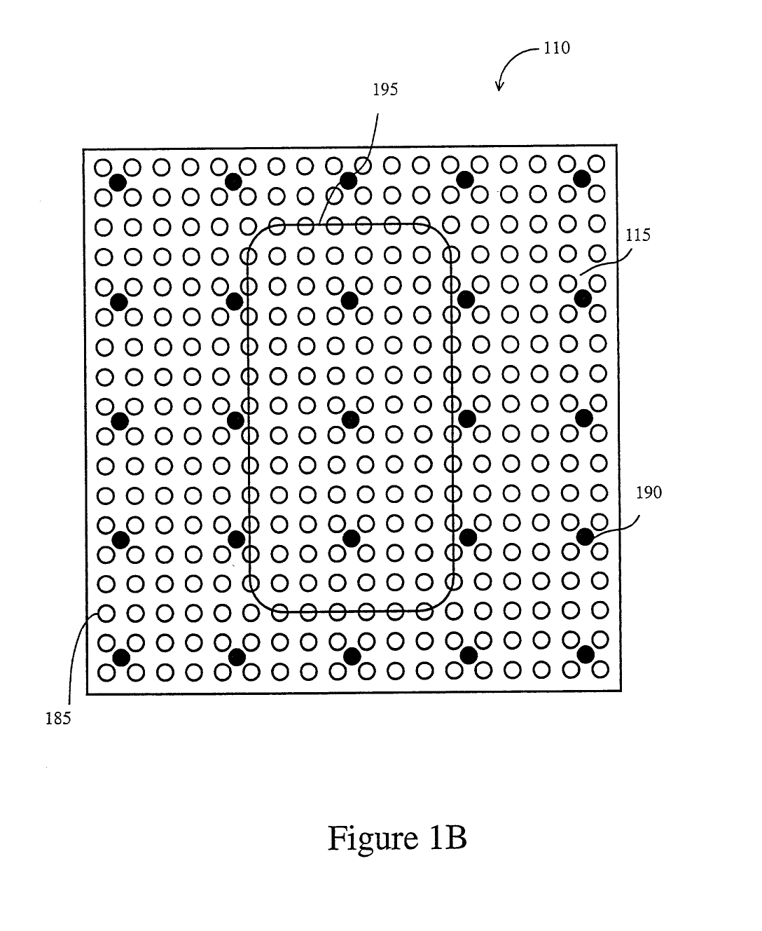

Referring to FIG. 1A, a remote optical graphic interface system 100 includes a controlling computer 105, an image projector 135 and an input matrix 130. The remote optical graphic interface system 100 further includes an array of display optical fibers 125, an array of detection optical fibers 120 and a display panel 110 further including a display and detection surface 115. The remote optical graphic interface system 100 also includes a photosensor array 145, a first light path 170, a second light path 175, a third light path 180, an optical pointing device 150, a targeting beam 155, and an activation beam 160. Controlling computer 105 further includes a data input device such as a data acquisition card (DAC) 140, for interfacing with photosensor array 145.

Photosensor array 145 is a matrix of light-sensitive detectors, light being defined in this case as visible light, ultraviolet light, or infrared light. Depending on the wavelength of light used by optical pointing device 150 for activation beam 160, light-sensitive detector array 145 may be comprised of photodiodes, phototransistors, cadmium sulfide cells, photomultiplier tubes, charge-coupled devices (“CCDs”), or other similar devices.

Image projector 135 is electrically connected to controlling computer or processing device 105. Photosensor array 145 is electrically connected with DAC 140 which, in turn, is part of controlling computer 105. Image projector 135 is optically coupled to input matrix 130 via first light path 170. Input matrix 130 is optically coupled to display and detection surface 115 via second light path 175 transmitted through display optical fibers 125. Optical fibers 125 are mechanically and optically connected to display and detection surface 115. Photosensor array 145 is optically coupled to detection optical fibers 120 via third light path 180. Detection optical fibers 120 are optically and mechanically connected to display and detection surface 115. Display and detection surface 115 is optically coupled to optical pointing device 150 via targeting beam 155. Detection optical fibers 120 are optically coupled to optical pointing device 150 via activation beam 160. Display panel 110 is mechanically connected to a frame (not shown) to provide structural support for installation and transporting.

In operation, controlling computer 105 provides an electronically encoded image (such as a composite video signal) to image projector 135. This signal may be transferred in either digital or analog format, and may be static or dynamic (that is, a sequence of images). Projector 135 projects the image through first light path 170 onto input matrix 130. Input matrix 130 apportions the image into display optical fibers 125 via second light path 175. Through the mechanism of total internal reflection, display optical fibers 125 transmit the apportioned image to display and detection surface 115, where display optical fibers 125 terminate. Display optical fibers 125 are arranged in an array (refer to FIG. 1B) of columns and rows on display and detection surface 115 and positioned so that the ends of the fibers are slightly recessed with respect to display and detection surface 115. Image segments launched from this optical fiber array are re-combined in the space in front of display and detection surface 115 to form a coherent magnified image as perceived by a viewer. This magnified image can be viewed from perspective points at some distance from display panel 110. Further, multiple display panels 110 may be optically and mechanically coupled as arrays of display “tiles” to form larger display surfaces, as shown and described in U.S. Pat. No. 6,304,703 entitled “Tiled Fiber Optic Display Apparatus,” incorporated herein by reference.

The exemplary system illustrated in FIG. 1A has a single image projector 135, input matrix 130, and display panel 110. Optionally, the system may include multiple input matrices, each positioned to receive a portion of first light path 170, as well as a corresponding display fiber array 125, detection fiber array 120, and display panel 110 for each input matrix. Also optionally, the controlling computer may control multiple image projectors 135 so that a separate image, or a portion of a single image, is projected by each projector.

Referring to FIG. 1B, display panel 110 as seen from a viewer's perspective includes display and detection surface 115, an array of display fiber endpoints 185, an array of detection fiber end-points 190, and displayed image 195. Display fiber end-points 185 and detection fiber end-points 190 are embedded in display panel 110 and conjoined in overlapping arrays as shown. Both arrays are uniformly distributed across the display surface, although the two arrays are typically characterized by different fiber pitches. Display fiber end-points 185 are represented by the open circles shown in FIG. 1B. Detection fiber end-points 190 are represented by dark circles, as shown in FIG. 1B. Preferably, the display panel 110 or a plurality of such display panels form a large screen display (“LSD”).

Each fiber end-point represents an optical fiber positioned behind display panel 110. Both display fiber end-points 185 and detection fiber end-points 190 are attached to display and detection surface 115 so that they are slightly recessed with respect to display and detection surface 115. The fibers may be affixed with optical epoxy (e.g., EpoTek 301) or held in fiber carriers. Exemplary panels and a method for manufacturing and using modular optical fiber display panels 110 are fully shown and described in U.S. Pat. No. 6,304,703 entitled “Tiled Fiber Optic Display Apparatus” and in pending U.S. patent application Ser. No. 09/718,745 entitled “A Large Screen Fiber Optic Display With High Fiber Density and Method for its Rapid Assembly,” each of which is commonly owned and assigned and incorporated herein by reference in their entirety.

The preferred density ratio of display fiber end-points 185 to detection fiber end-points 190 is approximately 10:1 (i.e., there is one detection fiber end-point 190 for every ten display fiber end-points 185). (In FIG. 1B, for the purpose of illustration, the density ratio is 13.) However, this ratio may be increased or decreased depending on the desired image resolution and desired detection resolution.

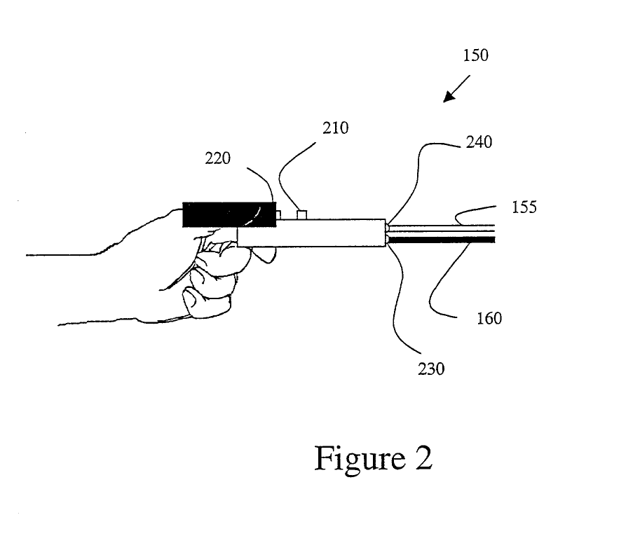

FIG. 2 illustrates an exemplary optical pointing device 150 that includes a targeting button 210, an activation button 220, an activation light source 230 with projection optics, a targeting light source 240 with projection optics, an activation beam 160, and a targeting beam 155. Targeting button 210 and activation button 220 are operatively fixed to optical pointing device 150. Activation light source 230 and targeting light source 240 include projection optics that are mechanically fixed to an exterior end of optical pointing device 150.

In operation, the user depresses targeting button 210 and targeting beam 155 is emitted from targeting light source 240. The user aims targeting beam 155 at a desired object imaged on display and detection surface 115. After the image of the displayed object is targeted, the user depresses activation button 220, causing activation beam 160 to be emitted from activation light source 230. Activation beam 160 impinges on the targeted displayed image and detection fiber end-points 190 (shown in FIG. 1B) that are coincident with the targeted object. Detection optical fibers 120 then transmit light from activation beam 160 to photosensor array 145.

Targeting beam 155 and activation beam 160 are preferably collimated light beams such as those emitted by a helium-neon (or other) laser. Targeting beam 155 is preferably a visible red light beam with a wavelength of typically 650 nm. Activation beam 160 is a visible or non-visible light beam. The preferred activation beam 160 is a blue or green beam with a wavelength of 440-540 nm. Photosensor array 145 incorporates an optical bandpass filter so that only light with the activation beam 160 wavelength is passed to the array (producing a signal) and all light outside of this wavelength band (including targeting beam 155) is absorbed or reflected. Alternatively, detection optical fibers 120 may be “doped” with coloring agents that enable only transmission of light of activation beam 160 wavelength. Alternatively, activation beam 160 and targeting beam 155 can be combined into a single beam that accomplishes both targeting and activation via modulation. For example, a single beam could target using a continuous beam and transmit an activation signal by modulating the beam at a predetermined frequency. A photosensor array 145 tuned to the modulation frequency of the activation beam would detect only the modulating beam and process the signal as previously described.

The distance a user may be disposed from the display to use the optical graphic interface is a minimum of 5 times the diagonal measurement of the LSD. For a typical hand-held laser pointer with an output beam power of 5 mW or less and a divergence angle of 1 mrad, distances up to 50 feet are practical while still maintaining a visible “spot” on the display. This distance is sufficient for most applications such as classrooms, lecture halls, conference halls, auditoriums, and other presentation milieux. Distances greater than this are feasible, but depend on the use of better-collimated lasers having higher output power for optical pointing device 150.

Alternatively, optical pointing device 150 may be fitted with a single button that triggers targeting beam 155 with a “half-click” of the button, and enables activation beam 160 with a “full-click” of the button.

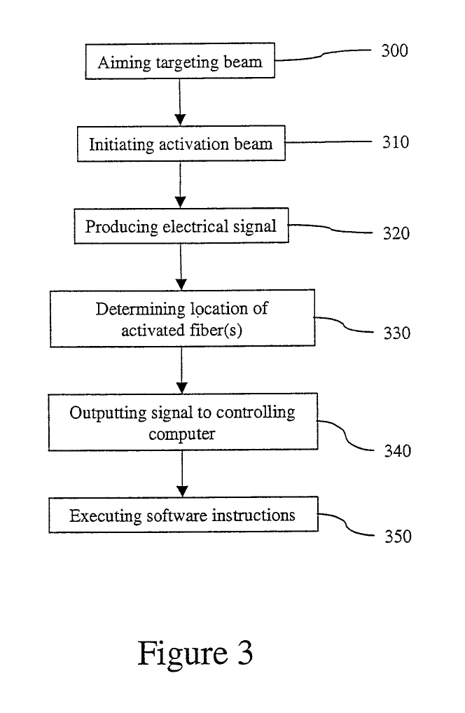

Referring to FIG. 3, a method for operating a remote optical graphic interface system includes the following steps.

Step 300: Aiming targeting beam

In this step, a user stands at a distance from the display, aims optical pointing device 150 at display panel 110, initiates targeting beam 155 by pressing targeting button 210, and aims targeting beam 155 at a selected object on the displayed image (such as a software application icon or menu item).

Step 310: Initiating activation beam

In this step, a user initiates activation beam 160 by pressing activation button 220 on optical pointing device 150. This beam impinges upon the selected display object and concomitant detection fiber end-points 190. Activation beam 160 and targeting beam 155 are approximately collinear, similar in beam diameter, but different in wavelength. This step is analogous to a “click” or “double-click” with a computer mouse. The activation beam 160 is then received by one or more of the detection optical fibers 120 at the detection surface 115.

Step 320: Producing electrical signal

In this step, light from activation beam 160 is conveyed through the detection optical fibers 120 to photosensor array 145, which generates an electrical signal. This signal may be proportional to the frequency and duration of activation beam 160 pulse.

Step 330: Determining location of activated fiber(s)

In this step, DAC 140, which samples all detection optical fiber 120 inputs via photosensor array 145, determines the location (x, y coordinates) where activation beam 160 impinged on display and detection surface 115.

Step 340: Transmitting signal to controlling computer

In this step, DAC 140 transmits the location of activation beam 160 on display and detection surface 115 and activation pulse configuration information to the controlling computer 105.

Step 350: Executing software instructions

In this step, controlling computer 105 executes software instructions according to the activation beam 160 display panel location and pulse configuration.

For example, a computer “desktop” display produced by a common software operating system such as Linux^{®} or Windows 2000^{®}, Windows NT^{®}, or Windows XP^{®} may be imaged on display and activation screen 115—complete with desktop icons. Each icon on the “desktop” represents a software application. A user wanting to start an application from an icon points to the icon with targeting beam 155. Once targeting beam 155 is located on the icon, the user initiates the activation beam 160 button on the optical pointing device, sending one or more short pulses of the activation beam 160 light to the display and detection surface 115. Detection optical fibers 120 detect the light pulses and transmit them to photosensor array 145. Photosensor array 145 converts the light pulses to electrical signals and transmits those signals to DAC 140. DAC 140 samples all of the detection optical fibers 120. In this way, DAC 140 determines the display screen location of the activation pulses and transmits this information to controlling computer 105. Software instructions in controlling computer 105 determine the appropriate action based on the signal coming from DAC 140—in this example, to start an application. The new image, based on the user's instruction, is then transmitted to display and detection surface 115.

LSD remote optical graphic interface system 100 can be applied to any displayed image requiring user interaction but is not limited to any particular software package. The technology may be used in conjunction with computer software such as (for example) Windows 98^{®}, Windows 2000^{®}, Windows NT^{®}, Windows XP^{®}, UNIX^{®}, MAC OS^{®}, Sun Solaris^{®}, and Palm OS^{®} (used on the PalmPilot^{®}).

Benefits of the present invention include the following. A first benefit of the present invention is that it is simple to use. A second benefit of the present invention is that it enables remote optical graphic interface to an LSD or other display from relatively large distances. A third benefit of the present invention is that it enables remote optical graphic interface with computer software delivering images to an LSD or other display regardless of the computer operating system.

It is to be understood that the invention is not limited in its application to the details of construction and to the arrangements of the components set forth herein or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this application is based may readily be employed as a basis for the designing of other structures, methods and systems for carrying out the several purposes of this invention. Further, since numerous modifications and variations will readily occur to those skilled in the art, the invention is not limited to the exact construction and operation illustrated and described, and accordingly, all appropriate modifications and equivalents fall within the scope of this invention.

The invention claimed is:

1. An optical graphic interface system, comprising:
a large screen display and detection surface panel;
a plurality of optical detection fibers in communication with the surface panel;
a photosensor array in optical communication with the array of optical detection fibers;
a plurality of optical display fibers in optical communication with the surface panel; and
an image projector and input matrix, the input matrix optically connected to the optical display fibers, the image projector positioned to transmit an image through the input matrix and the optical display fibers to the surface panel.

2. The system of claim 1 further comprising a computing device, wherein the image projector and the photosensor array are each in communication with the computing device.

3. The system of claim 1 wherein the surface panel is connected to a support structure that is designed to support a plurality of surface panels.

4. The system of claim 1 wherein the surface panel has a surface area larger than the surface area of the input matrix, and the optical display fibers are arranged so that the image is magnified when transmitted from the input matrix to the surface panel.

5. The system of claim 1 wherein each of the plurality of optical display fibers and each of the plurality of optical detection fibers has an end-point, and the plurality of optical display fibers and the plurality of optical detection fibers are arranged so that both the optical display fiber end points and the optical detection fiber end points are co-distributed uniformly across the surface panel.

6. The system of claim 1 wherein the plurality of optical display fibers is greater than the plurality of optical detection fibers.

7. The system of claim 1 further comprising an optical pointing device including:
a targeting light source capable of emitting light having a first wavelength;
a first actuator capable of turning the targeting light source on and off;
an activation light source capable of emitting light having a second wavelength, wherein the second wavelength is different from the first wavelength; and
a second actuator capable of turning the activation light source on and off.

8. The system of claim 7 wherein the targeting light source and the activation light source comprise a single light source, the single light source being capable of emitting light having the first wavelength and also light having the second wavelength.

9. The system of claim 7 wherein the targeting light source and the activation light source comprise a single light source, the single light source being capable of emitting light of a given wavelength having a first modulation frequency and light of the same wavelength having a second modulation frequency, wherein the first modulation frequency and the second modulation frequency are different.

10. The system of claim 9 wherein either the first modulation frequency or the second modulation frequency, but not both, is zero.

11. The system of claim 7 wherein the first actuator and the second actuator comprise a single actuator having at least two modes of operation.

12. The system of claim 1 wherein the photosensor array includes at least one optical bandpass filter designed to pass predetermined light spectra and reflect or absorb other predetermined light spectra.

13. An optical graphic interface system, comprising:
a large screen display and detection surface panel;
a plurality of optical detection fibers in communication with the surface panel;
a photosensor array in optical communication with the array of optical detection fibers, the photosensor array including at least one optical bandpass filter designed to pass predetermined light spectra and reflect or absorb other predetermined light spectra;
a plurality of optical display fibers in optical communication with the surface panel; and
an image projector and input matrix, the input matrix optically connected to the optical display fibers, the image projector positioned to transmit an image through the input matrix and the optical display fibers to the surface panel; and
an optical pointing device including:
at least one light source, said light source being capable of emitting light having a first wavelength and light having a second wavelength; and
at least one actuator capable of turning said light source on and off.

14. A method of displaying content to a user, comprising:
receiving, via a large screen display via a plurality of optical detection fibers, light having a predetermined wavelength;
determining a location on the large screen display with which the light has communicated;
converting the light into an electrical signal using at least one photosensor;
transmitting the electrical signal to a computing device having a data acquisition card;
selecting, by a computing device, a response to the electrical signal; and
transmitting, via a plurality of optical display fibers to the display surface, at least one image corresponding to the response.
